(19) United States
(12) Patent Application Publication
(10) Pub. No.: US 2018/0059526 A1
(43) Pub. Date: Mar. 1, 2018

(54) OPTICAL PROJECTION APPARATUS AND PROJECTOR

(71) Applicant: SEIKO EPSON CORPORATION, Tokyo (JP)

(72) Inventors: Naoto TAKEHANA, Matsumoto-Shi (JP); Nobuyuki OTSUKI, Matsumoto-Shi (JP); Satoshi KOMATSU, Shiojiri-Shi (JP)

(73) Assignee: SEIKO EPSON CORPORATION, Tokyo (JP)

(21) Appl. No.: 15/557,260

(22) PCT Filed: Mar. 1, 2016
(86) PCT No.: PCT/JP2016/001090

§ 371 Date: Sep. 11, 2017

(30) Foreign Application Priority Data
Mar. 25, 2015 (JP) 2015-062190
Oct. 27, 2015 (JP) 2015-210544

(51) Int. Cl. G03B 21/28; G03B 21/20; G02B 27/10; G02B 13/18; G02B 27/28; H04N 9/31

(52) U.S. Cl. CPC G03B 21/28; G03B 21/2073; G02B 27/1026; H04N 9/315; G02B 13/18; G02B 27/283; G02B 27/1046

(57) ABSTRACT

A optical projection apparatus including a refractive system and a reflective system includes a optical projection enclosure and a light transmissive plate, which transmits projection light. The optical projection enclosure includes a light transmissive plate holding section. An interposing member (a first interposing member, a second interposing member) having elasticity is provided between the light transmissive plate and the holding section, and the interposing member covers the entirety of divided portions of the holding section. The first interposing member is disposed in the holding section or on a side section of the light transmissive plate, and the second interposing member is disposed on an outer circumferential end surface of the light transmissive plate. The interposing member is pressed by the light transmissive plate and held in the light transmissive plate holding section.

### TECHNICAL FIELD

The present invention relates to a optical projection apparatus and a projector including the optical projection apparatus.

### BACKGROUND ART

There is a known projector of related art in which a light modulator modulates light emitted from a light source (emitted light) in accordance with image information and a optical projection apparatus enlarges and projects the modulated light. Some projectors project a wide-field-angle image on a screen or any other projection surface over a short distance. In such a projector, a short throw optical projection apparatus is used as the optical projection apparatus capable of wide-field-angle projection over a short distance. In recent years, a projection system for achieving a wide filed angle over a short distance is formed of not only a refractive system but a refractive/reflective compound system.

The optical projection apparatus typically includes a optical projection enclosure that accommodates the refractive/reflective compound system. The optical projection enclosure is accommodated, for example, in an exterior enclosure of the projector. In the optical projection enclosure, a light transmissive plate that transmits light reflected off the reflection system and traveling through the optical projection enclosure toward a screen is provided. The light having passed through the light transmissive plate exits through an opening provided in the exterior enclosure of the projector and formed in correspondence with the light transmissive plate.

Further, the projector includes a cooling mechanism provided in the exterior enclosure. The cooling mechanism drives a cooling fan that forms the cooling mechanism to cause outside air to flow into the exterior enclosure and blows the outside air having flowed in as cooling air on optical parts that generate heat to cool the optical parts. The projector is provided with a filter for removing dust contained in the outside air caused to flow into the exterior enclosure.

PTL 1 discloses an inexpensive, compact mirror-type projection system including a small mirror and capable of producing a satisfactory image without compromising wide-angle projection.

### CITATION LIST

### Patent Literature

PTL 1: JP-A-2012-203139

### SUMMARY OF INVENTION

### Technical Problem

In a case where the dust keeps adhering to the filter provided in the projector, clogging tends to occur in the filter. In the case where clogging occurs in the filter, when the cooling fan is driven, the outside air instead flows into the exterior enclosure through gaps between components that form the projector. In this case, the dust directly flows into the exterior enclosure.

Even a optical projection apparatus accommodated in an exterior enclosure is no exception, and the dust flows via the opening of the exterior enclosure into the optical projection enclosure through a gap between the light transmissive plate and the optical projection enclosure, in which the light transmissive plate is disposed. In the case where the dust flows into the optical projection enclosure, the dust adheres to the surfaces and other portions of a variety of lenses that form the optical system. When an image is projected with the dust attached to the surfaces and other portions of the variety of lenses, the dust is projected in the form of shadows on the screen or any other surface. The quality of the projected image therefore undesirably decreases.

It has therefore been desired to provide a optical projection apparatus that suppresses entry of the dust flowing into the optical projection enclosure through the gap between the light transmissive plate and the optical projection enclosure and further provide a projector including the optical projection apparatus.

### Solution to Problem

The invention has been made to achieve at least part of the object described above and can be implemented in the following forms or application examples:

### APPLICATION EXAMPLE 1

A optical projection apparatus according to this application example is a optical projection apparatus including a refractive system having a plurality of lenses and a reflective system having a reflection mirror, the optical projection apparatus characterized in that: the optical projection apparatus includes a optical projection enclosure that accommodates the refractive system and the reflective system and a light transmissive plate that is disposed in the optical projection enclosure and transmits projection light having exited out of the reflective system; the optical projection enclosure includes a light transmissive plate holding section that holds the light transmissive plate; the light transmissive plate holding section includes an opening through which the projection light passes and a holding section which is formed along the opening and in which the light transmissive plate is disposed; an interposing member having elasticity is provided between the light transmissive plate and the holding section; the interposing member is formed of a first interposing member and a second interposing member that correspond to divided portions of the holding section and cover the entire holding section; the first interposing member is disposed in the holding section or on a side section of the light transmissive plate, and the second interposing member is disposed on an outer circumferential end surface of the light transmissive plate; and the light transmissive plate presses the first interposing member and the second interposing member against the holding section and is held by the light transmissive plate holding section.

The thus configured optical projection apparatus includes the first interposing member and the second interposing member, which correspond to divided portions of the holding section and cover the entire holding section, and the light transmissive plate presses the first interposing member and the second interposing member against the holding section and is held by the light transmissive plate holding section. As a result, since the interposing members can close the gap between the light transmissive plate and the optical projection enclosure (light transmissive plate holding section), entry of dust flowing into the optical projection enclosure can be suppressed.

Further, since the first interposing member is disposed in the holding section or the side section of the light transmissive plate, and the second interposing member is disposed on the outer circumferential end surface of the light transmissive plate, even a case where the interposing member cannot be uniformly disposed in the holding section, for example, a case where the holding section of the light transmissive plate holding section is not uniformly shaped or a case where the holding section is oddly shaped, can be handled.

### APPLICATION EXAMPLE 2

In the optical projection apparatus according to the application example described above, it is preferable that the light transmissive plate has a rectangular shape, that the holding section corresponding to an outer circumferential end surface of the light transmissive plate facing one side thereof has an insertion section into which the outer circumferential end surfaces is inserted, that the second interposing member is disposed on the outer circumferential end surfaces facing the one side, and that the first interposing member is disposed on side sections of the light transmissive plate facing other three sides thereof or in the holding section corresponding to the side sections.

According to the optical projection apparatus described above, in the case where the light transmissive plate has a rectangular shape and the holding section corresponding to the outer circumferential end surface of the light transmissive plate facing one side thereof has the insertion section, the second interposing member is disposed on the outer circumferential end surface of the light transmissive plate facing the one side thereof. Therefore, when the light transmissive plate is inserted into the insertion section, the outer circumferential end surface of the light transmissive plate facing the one side thereof can be inserted into the insertion section without separation of the second interposing member, whereby the second interposing member can be pressed against the holding section. Further, the first interposing member is disposed on the side sections of the light transmissive plate facing the other three sides thereof or in the holding section corresponding to the side sections. Therefore, when the light transmissive plate is inserted into the insertion section, the first interposing member and the second interposing member can be pressed. As a result, the gap between the light transmissive plate and the holding section can be closed, whereby entry of dust flowing into the optical projection enclosure can be suppressed.

### APPLICATION EXAMPLE 3

In the optical projection apparatus according to the application example described above, it is preferable that the light transmissive plate has a rectangular shape, that a pressing member that presses any of the side sections of the light transmissive plate on which the first interposing member is disposed is provided, and that the pressing member holds the light transmissive plate in the light transmissive plate holding section.

According to the optical projection apparatus described above, out of the side sections of the light transmissive plate, the side section on which the first interposing member is disposed is pressed by the pressing member. The light transmissive plate is therefore stably held in the light transmissive plate holding section with the interposing member pressed.

### APPLICATION EXAMPLE 4

In the optical projection apparatus according to the application example described above, it is preferable that the first interposing member and the second interposing member are each formed of a cushioning member.

According to the optical projection apparatus described above, since the first interposing member and the second interposing member are each formed of a cushioning member, the first interposing member and the second interposing member can be readily formed.

### APPLICATION EXAMPLE 5

A projector according to this application example is characterized in that the projector includes a light source apparatus that outputs light, a light modulator that modulates the light in accordance with image information, any of the optical projection apparatus described above, which projects the light modulated by the light modulator, and an exterior enclosure that accommodates the light source apparatus, the light modulator, and the optical projection apparatus and forms an exterior of the projector, and the exterior enclosure has, in correspondence with the opening of the optical projection enclosure, an opening through which the projection light having passed through the opening of the optical projection enclosure passes.

The projector described above, which includes the optical projection apparatus capable of suppressing entry of dust flowing into the optical projection enclosure through the gap between the light transmissive plate and the optical projection enclosure, allows improvement in the quality of a projected image.

### BRIEF DESCRIPTION OF DRAWINGS

FIG. 1 is a perspective view showing the form in which a projector according to an embodiment of the invention is used.

FIG. 2 diagrammatically shows an optical unit of the projector.

FIG. 3 is a perspective view of a optical projection apparatus.

FIG. 4 is a schematic cross-sectional view of the optical projection apparatus.

FIG. 5 is an exploded perspective view of a light transmissive plate holding section, a light transmissive plate, and an interposing member.

FIG. 6 is a schematic cross-sectional view of a state in which the light transmissive plate is held in a holding section.

FIG. 7 is a perspective view showing an upper enclosure according a variation.

FIG. 8 is a plan view of the upper enclosure in which the light transmissive plate is disposed and which is viewed from the side where the light transmissive plate is present in the variation.

### DESCRIPTION OF EMBODIMENTS

An embodiment will be described below with reference to the drawings.

### Embodiment

[Form in which Projector 1 is Used and Operation of Projector 1]

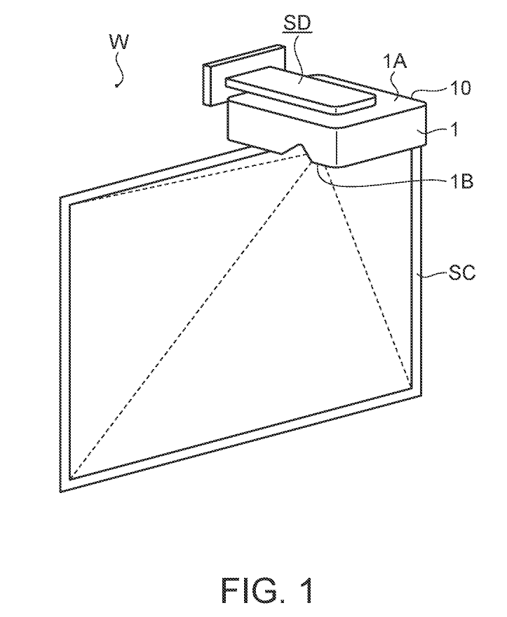

FIG. 1 is a perspective view showing the form in which a projector 1 according to the present embodiment is used. The projector 1 includes a optical projection apparatus 5 according to the present embodiment accommodated in an exterior enclosure 10 of the projector 1.

The projector 1 according to the present embodiment is supported by a support apparatus SD, which is installed on a wall surface W, and so installed that a bottom surface 1A faces upward and a top surface 1B faces downward, as shown in FIG. 1. A screen SC as a projection surface is installed on a lower portion of the wall surface W, on which the projector 1 is installed, and in a position close to the projector 1.

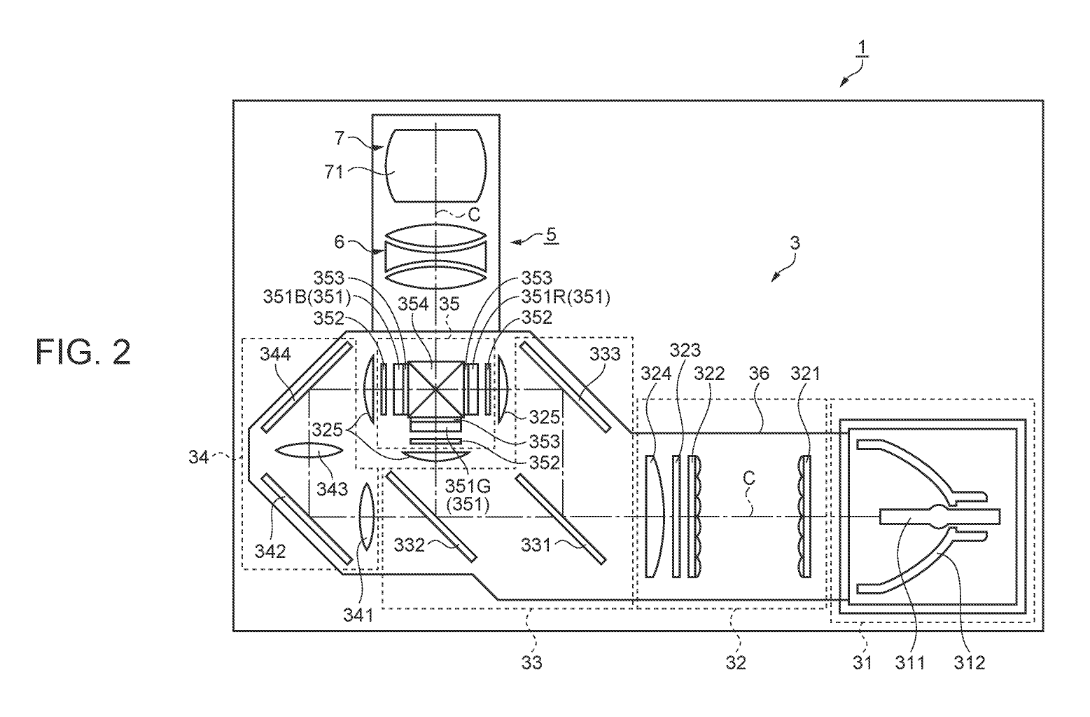

In the projector 1, liquid crystal panels 351 (see FIG. 2) as light modulators modulate light outputted from a light source apparatus 31 (see FIG. 2) in accordance with image information, and the optical projection apparatus 5 (see FIG. 2) enlarges and projects the modulated light as image light. The projector 1 projects the image light (projection light), which is reflected off a reflection system (reflection mirror (see FIG. 2 and the following figures)) in the optical projection apparatus 5, from the side opposite the bottom surface LA on the screen SC. The projector 1 according to the present embodiment is configured as what is called a short throw projector, which projects an image in the form of a large (wide-field-angle) screen on the screen SC over a short distance.

### [Configuration and Operation of Optical Unit 3 of Projector 1]

FIG. 2 diagrammatically shows an optical unit 3 of the projector 1. The optical unit 3 operates under the control of a controller (not shown) to form image light in accordance with image information. The optical unit 3 includes the light source apparatus 31, which includes a light source lamp 311 and a reflector 312, and an illumination optical apparatus 32, which includes lens arrays 321 and 322, a polarization conversion element 323, a superimposing lens 324, and parallelizing lenses 325, as shown in FIG. 2. The optical unit 3 further includes a color separation optical apparatus 33, which includes dichroic mirrors 331 and 332 and a reflection mirror 333, and a relay optical apparatus 34, which includes a light-incident-side lens 341, a relay lens 343, and reflection mirrors 342 and 344.

The optical unit 3 still further includes an electro-optical apparatus 35, which includes three liquid crystal panels 351 (reference character 351R denotes a liquid crystal panel for red light (R light), reference character 351G denotes a liquid crystal panel for green light (G light), and reference character 351B denotes a liquid crystal panel for blue light (B light)), three light-incident-side polarizers 352, three light-exiting-side polarizers 353, and a cross dichroic prism 354 as a light combining optical apparatus. The optical unit 3 still further includes the optical projection apparatus 5 and an optical part enclosure 36, which accommodates the optical apparatus 31 to 35.

In the optical unit 3 having the configuration described above, the color separation optical apparatus 33 separates the light having been outputted from the light source apparatus 31 and having passed through the illumination optical apparatus 32 into three color light fluxes, R light, G light, and B light. The separated color light fluxes are modulated by the respective liquid crystal panels 351 in accordance with image information to form modulated color light fluxes. The modulated color light fluxes are incident on the cross dichroic prism 354, which combines the light fluxes with one another into image light, which is enlarged and projected via the optical projection apparatus 5 on the screen SC (FIG. 1) or any other surface. Each of the optical apparatus 31 to 35 described above is used as an optical system of a variety of typical projectors and will not therefore specifically described.

### [Overview of Optical Projection Apparatus 5]

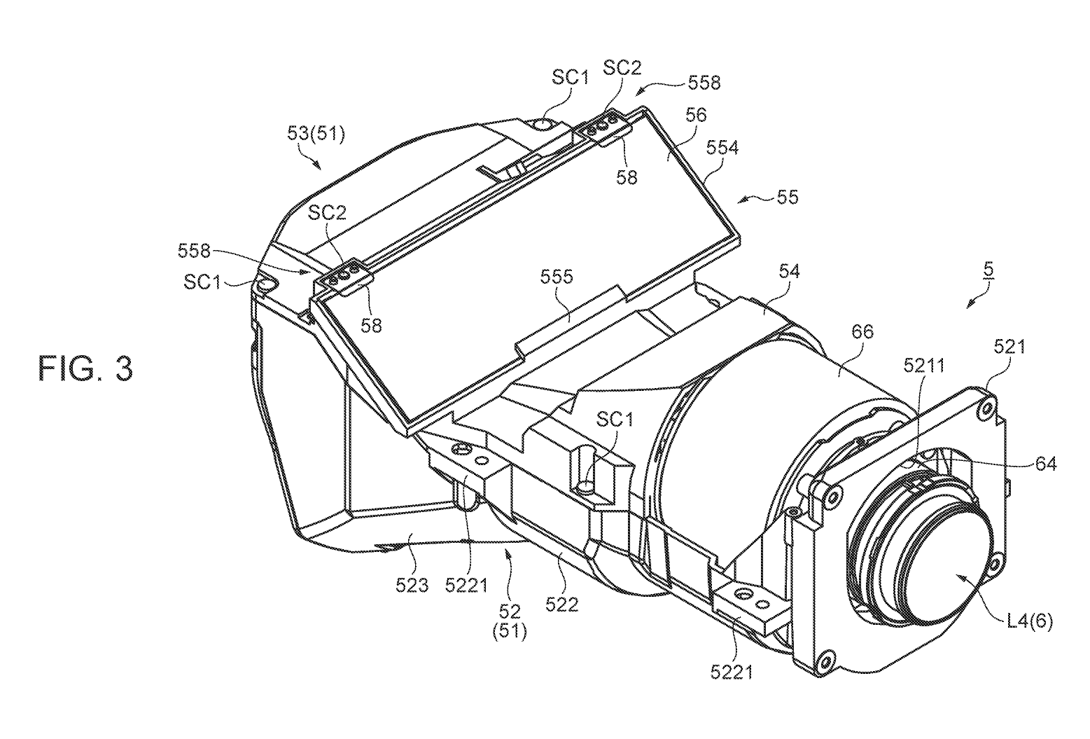

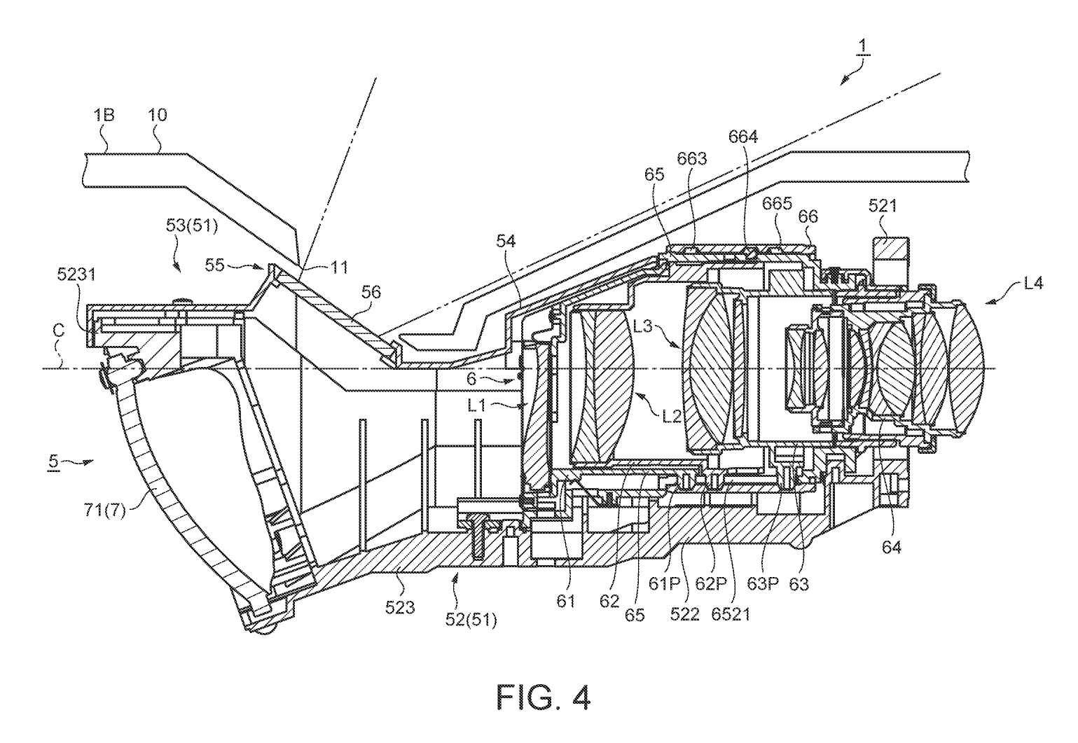

FIG. 3 is a perspective view of the optical projection apparatus 5. FIG. 4 is a schematic cross-sectional view of the optical projection apparatus 5. FIG. 3 is a perspective view of the rear side of the optical projection apparatus 5 viewed from above. FIG. 4 is a cross-sectional view of the optical projection apparatus 5 taken along a plane including an optical axis C and extending along the upward/downward direction. The optical projection apparatus 5 will be schematically described, including the configuration and operation of each member that forms the optical projection apparatus 5, with reference to FIGS. 3 and 4. In FIG. 4, an interposing member 57 is omitted.

For ease of description, in FIG. 3 and the following figures, the light incident side where the image light is incident on a refraction system (first optical system 6) of the optical projection apparatus 5 is called a rear side, and the light exiting side where the image light exits out of the first optical system 6 is called a front side. Further, in FIG. 3, the upward direction with respect to the plane of view is called an upper side, and the downward direction with respect to the plane of view is called a lower side. Still further, the rightward and leftward directions viewed from the light exiting side, where the image light exits out of the first optical system 6, is called right and left sides, respectively, which are used in the description as appropriate. The optical projection apparatus 5 is therefore installed with the upper and lower sides reversed and the right and left sides reversed in the state shown in FIG. 1, in which the projector 1 is used. In this state, the upper and lower sides of the projector 1 are reversed, and the right and left sides thereof are reversed.

The optical projection apparatus 5 is configured, as a projection system, in the form of an optical system formed of a combination of the first optical system. 6 (refractive system) and a second optical system 7 (reflective system), as shown in FIGS. 3 and 4. In the optical projection apparatus 5 according to the present embodiment, the first optical system 6 refracts the image light having exited out of the cross dichroic prism 354, and the second optical system 7, which is formed of a reflection mirror 71, reflects the image light and projects it on the screen SC. The optical projection apparatus 5 includes, as the first optical system 6, a plurality of lens groups each of which is formed of one or more lenses, and the lens groups are arranged along the optical axis C. The optical projection apparatus 5 according to the present embodiment is configured as a short throw optical projection apparatus, and the first optical system 6 has the function of performing focus adjustment on the image light incident thereon.

The optical projection apparatus 5 generally includes a optical projection enclosure 51, which forms a base of the apparatus, the first optical system 6 and the second optical system 7, which are accommodated in the optical projection enclosure 51, and a light transmissive plate 56, which transmits light reflected off the reflection mirror 71 (projection light). The optical projection enclosure 51 includes a lower enclosure 52, which accommodates the first optical system 6 and the second optical system 7, and an upper enclosure 53, which covers the upper side of the lower enclosure 52 and holds the light transmissive plate 56.

The first optical system 6 includes a guide barrel 65, a cam barrel 66, a first lens group L1 to a fourth lens group L4, which are sequentially arranged from the front side along the optical axis C, and a first lens frame 61 to a fourth lens frame 64, which hold the corresponding lens groups L1 to L4, respectively. The second optical system 7 includes the reflection mirror 71, which has an aspheric surface.

In the optical projection apparatus 5, the first optical system 6 optically processes the image light incident through the fourth lens group L4 and outputs the processed image light through the first lens group L1 toward the reflection mirror 71 of the second optical system 7, and the reflection mirror 71 reflects the outputted image light to output the reflected image light as the projection light upward with respect to the first lens group L1. The first lens group L1 is the forefront lens group in the first optical system 6, which outputs light toward the reflection mirror 71.

### [Schematic Configuration of Lower Enclosure 52]

The lower enclosure 52 of the optical projection enclosure is formed of a flange 521, which is disposed at the light-incident-side end, a first accommodation section 522, which extends frontward from the flange 521, and a second accommodation section 523, which extends from the first accommodation section 522 and spreads toward the front side. The flange 521 has a rectangular shape in a plan view, and the electro-optical apparatus 35 is fixed to the rear end surface of the flange 521. The flange 521 has an insertion hole 5211 formed in a central portion thereof, and the rear side of the fourth lens frame 64, which holds the fourth lens group L4, is inserted through the insertion hole 5211.

The first accommodation section 522 has a roughly half-cylindrical shape that is a roughly cylindrical shape with the upper side above the central axis thereof cut off and accommodates the first optical system 6. Fixing sections 5221 for fixing the optical projection apparatus 5 to a fixing member (not shown) in the projector 1 are formed at the upper end of the first accommodation section 522 and on the front and rear sides thereof.

The second accommodation section 523 has a roughly half-cylindrical shape (half-frustum shape) that is a frontward spreading tubular shape with the upper side above the central axis thereof cut off. A front end section 5231 of the second accommodation section 523 is open, and the reflection mirror 71 is disposed on an inner surface of the second accommodation section 523 and in the vicinity of the front end section 5231.

### [Schematic Configuration of Upper Enclosure 53]

The upper enclosure 53 of the optical projection enclosure 51 is so disposed as to cover a portion of the upper side of the lower enclosure 52, the portion from the front end section 5231 of the second accommodation section 523 roughly to a front-side middle portion of the first accommodation section 522. The upper enclosure 53 generally includes a light transmissive plate holding section 55, which holds the light transmissive plate 56, which has a rectangular shape and is transparent so as to transmit the projection light reflected off the reflection mirror 71, in such a way that the light transmissive plate 56 is roughly perpendicular to a projection optical axis that is a line connecting the centers of the projection light flux to one another, and an inclining section 54, which is formed at an angle that allows the inclining section 54 not to block the projection light having passed through the light transmissive plate 56.

The upper enclosure 53 is fixed to the upper end of the lower enclosure 52 with screws SC1. The upper enclosure 53 fixed to the lower enclosure 52 prevents light having exited out of the first optical system 6 and the second optical system 7 and other light fluxes from leaking out of the apparatus. Fixing the upper enclosure 53 to the lower enclosure 52 allows the area where the upper enclosure 53 and the lower enclosure 52 engage with each other to be fixed to each other with the two enclosures being in contact with each other, preventing as much as possible the area from being a gap. Entry of dust and other foreign matter into the optical projection enclosure 51 is therefore suppressed.

In the present embodiment, the optical projection apparatus 5 is installed in the exterior enclosure 10, which forms the exterior of the projector 1. An opening 11 is formed in the upper surface 1B of the projector 1 (exterior enclosure 10) in correspondence with the outer shape of the light transmissive plate 56 (opening 551 of light transmissive plate holding section 55), and opening 11 allows passage of the projection light having passed through the light transmissive plate 56 (having passed through opening 551).

### [Configuration and Operation of Optical System of Optical Projection Apparatus 5]

A straight groove 6521 is formed in the guide barrel 65 and is a cutout extending from the front side toward the rear side of the guide barrel 65 along the direction of the optical axis C. The guide barrel 65 covers the outer circumferential side of the first lens frame 61 and the second lens frame 62. The guide barrel 65 is fixed to an inner portion of the lower enclosure 52 with screws.

The cam barrel 66 has a cylindrical shape, and part of the guide barrel 65 is inserted and fit into the cam barrel 66 so that the cam barrel 66 is pivotable around the optical axis C relative to the guide barrel 65. In the inner circumferential surface of the cam barrel 66 are formed a guide groove (not shown), which is a cutout formed from a front end portion toward a rear side section of the cam barrel 66 along the direction of the optical axis C, and cam grooves 663, 664, and 665, which are formed along predetermined paths to define movement of the first lens group L1 to the third lens group L3.

A fixing section (not shown) that fixes a lever member that is not shown is formed on the outer circumferential surface of the cam barrel 66. To perform the focus adjustment, the lever member is caused to pivot. The cam barrel 66 is then caused to pivot relative to the guide barrel 65 for the focus adjustment.

The first lens group L1, the second lens group L2, and the third lens group L3 are held by the first lens frame 61, the second lens frame 62, and the third lens frame 63, respectively, which are so inserted and fit into the guide barrel 65 as to be movable along the optical axis C, as shown in FIG. 4. Cam pins 61P, 62P, and 63P are formed on the lens frames 61, 62, and 63, respectively, and the cam pins 61P, 62P, and 63P engage with the straight groove 6521 in the guide barrel 65 and the cam grooves 663, 664, and 665 in the cam barrel 66.

The lens frames 61, 62, and 63 move along the direction of the optical axis C when the intersections of the straight groove 6521 and the cam grooves 663, 664, and 665 guide the cam pins 61P, 62P, and 63P in response to the pivotal motion of the cam barrel 66. The movement causes the lens groups L1, L2, and L3 to move, whereby focus adjustment is performed on the image light.

The fourth lens group L4 is held by the fourth lens frame 64, and the fourth lens frame 64 is inserted and fit into the guide barrel 65. The fourth lens group L4 is caused to pivot relative to the guide barrel 65 for back focus adjustment. After the adjustment, the fourth lens group L4 is fixed to the guide barrel 65.

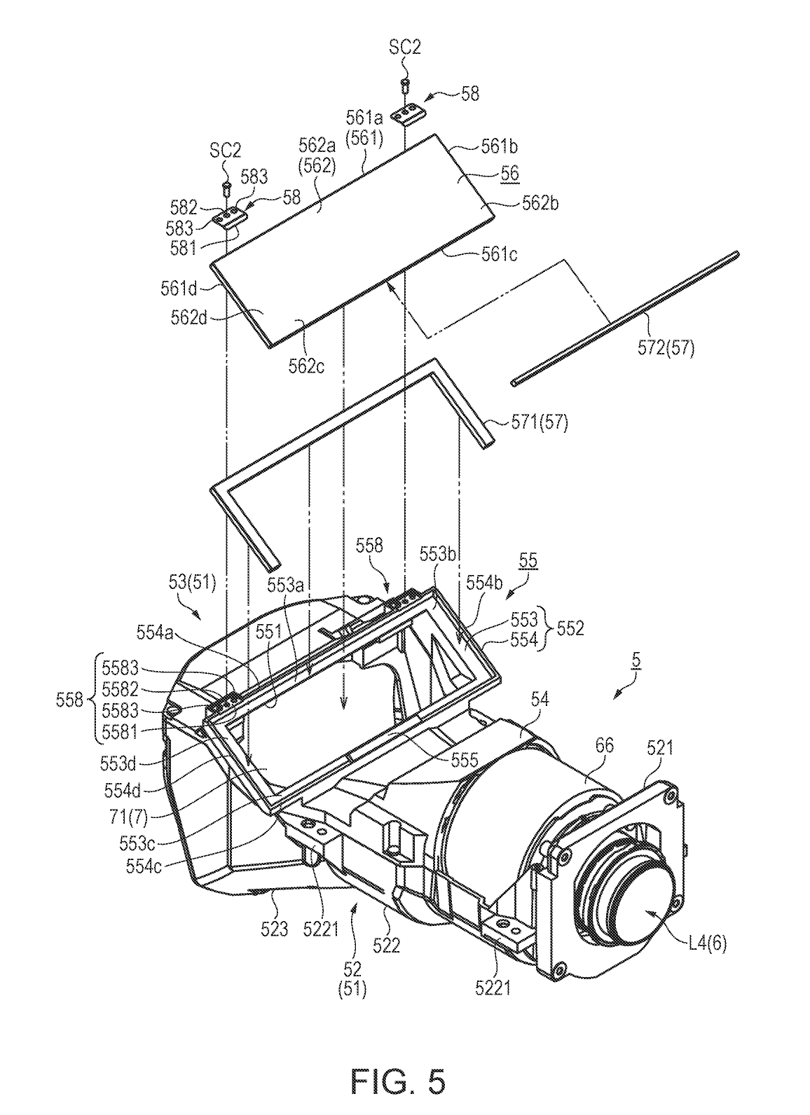

FIG. 5 is an exploded perspective view of the light transmissive plate holding section 55, the light transmissive plate 56, and the interposing member 57. The configurations, assembly, and functions of the light transmissive plate holding section 55, the light transmissive plate 56, and the interposing member 57 will be described with reference to FIGS. 3 to 5.

### [Configuration of Light Transmissive Plate 56]

The light transmissive plate 56 is a member that transmits the image light reflected off the reflection mirror 71 to cause the image light to exit out of the optical projection apparatus 5. In the present embodiment, since the opening 11 (see FIG. 4) of the exterior enclosure 10, which accommodates the optical projection apparatus 5, is open, the light transmissive plate 56 functions as the exterior and is exposed to the outside. The light transmissive plate 56 is formed of a transparent glass member in the present embodiment. The light transmissive plate 56 has a rectangular shape.

In the following sections, for ease of description, it is assumed that an outer circumferential end surface 561, which forms the four sides of the light transmissive plate 56, is formed of outer circumferential end surfaces 561a, 561b, 561c, and 561d clockwise from the upper-side end surface. It is further assumed that a side section 562, which is an area facing the four sides of the light transmissive plate 56 and in the vicinity of the outer circumferential end surfaces 561, is formed of side sections 562 and specifically called side sections 562a, 562b, 562c, and 562d clockwise from the upper-side side section.

### [Configuration of Light Transmissive Plate Holding Section 55]

The light transmissive plate holding section 55 is a portion configured to hold the light transmissive plate 56 in a holding section 552, which will be described later, for fixation of the light transmissive plate 56. The light transmissive plate holding section 55 is configured in accordance with the outer shape of the light transmissive plate 56. The light transmissive plate holding section 55 has a rectangular opening 551, through which the projection light passes, as shown in FIG. 5. The light transmissive plate holding section 55 further includes the holding section 552, which is formed along the opening 551 and holds the light transmissive plate 56. The holding section 552 has a holding surface section 553, which is formed along the rectangular opening 551 and formed of a uniform surface having four side sections having roughly the same width, and a wall section 554, which protrudes upward from the holding surface section 553.

In the following sections, for ease of description, it is assumed that the holding surface section 553 is formed of holding surface sections 553a, 553b, 553c, and 553d clockwise from the upper-side holding surface section. It is further assumed that the wall section 554 is formed of wall sections 554a, 554b, 554c, and 554d clockwise from the upper-side wall section.

An upper holding section 555 is formed in a central portion of the lower wall section 554c, which faces one side of the wall sections 554, and protrudes from the top surface of the wall section 554c and extends toward the opening 551. An insertion section is formed in the area surrounded by the upper holding section 555, the holding surface section 553c, and the wall section 554c. The outer end surface 561c of the light transmissive plate 56 is inserted into the insertion section. Fixing sections 558 are formed on opposite end portions of the upper wall section 554a, which faces the wall section 554c, which faces the one side.

### [Configuration of Fixing Sections 558]

The fixing section 558 are each a portion configured to fix the light transmissive plate 56 disposed in the holding section 552 with fixing plates 58, which will be described later. The fixing sections 558 each have a placement surface 5581, on which the corresponding fixing plate 58 is placed, and a threaded hole 5582, which is formed in a central portion of the fixing section 558. Further, dowels 5583 for positioning the fixing plate 58 are formed on opposite sides of the treaded hole 5582.

### [Configuration of Fixing Plates 58]

The fixing plates 58, which serve as pressing members, are members that are disposed in the fixing sections 558 and press the light transmissive plate 56 to fix it to the holding section 552. The fixing plates 58 are each formed of a metal plate member and have a rectangular shape. The fixing plates 58 each have one end surface 581 bent in accordance with the inclination angle of the holding section 552. Further, the fixing plates 58 each have a hole 582 formed in a roughly central portion thereof, and a screw SC2 is inserted through the hole 582. Positioning holes 583 are further formed on opposite sides of the hole 582.

### [Configuration of Interposing Member 57]

In the present embodiment, the interposing member 57 is disposed between the light transmissive plate 56 and the holding section 552. The interposing member 57 compresses, when pressed, in the pressing direction and therefore has the function of closing a gap created when the light transmissive plate 56 is disposed in the holding section 552.

The interposing member 57 is formed of a first interposing member 571 and a second interposing member 572 in the present embodiment. The interposing member 57 is so formed that the first interposing member 571 and the second interposing member 572, which correspond to divided portions of the holding section 552, cover the entire holding section 552. In the present embodiment, the first interposing member 571 and the second interposing member 572 are each formed of a cushioning member having elasticity. In detail, the first interposing member 571 and the second interposing member 572 are made of polyethylene resin foam having a three-dimensional mesh structure, as the cushioning member, but not necessarily, and the cushioning member may instead be formed of a urethane-based sponge having a three-dimensional mesh structure. The cushioning member may still instead be a rubber member having elasticity.

The first interposing member 571 is disposed on the holding surface sections 553a, 553b, and 553d, which face three sides of the holding surface section 553, as shown in FIG. 5. The first interposing member 571 is so formed in correspondence with the shape of the holding surface section 553 facing the three sides as to have a frame-like, plate-like shape with the lower one side cut off. An adhesive is disposed on the lower surface of the first interposing member 571. The adhesive is what is called a double-sided adhesive tape (not shown), which is a tape with an adhesive applied onto both sides thereof in the present embodiment.

The second interposing member 572 is disposed on the outer circumferential end surface 561c, which faces one side of the light transmissive plate 56, as shown in FIG. 5. The second interposing member 572 is so formed in correspondence with the shape of the outer circumferential end surface 561c as to have a rectangular, plate-like shape. The double-sided adhesive tape (not shown) described above is attached to one end surface of the second interposing member 572.

### [Disposing Interposing Member 57]

The first interposing member 571 is disposed on (attached to) from above the holding surface sections 553a, 553b, and 553d, which face three sides of the holding surface section 553, as described above. In other words, the first interposing member 571 is attached to the holding section 552 corresponding to the side sections 562a, 562b, and 562d, which face the three sides, of the light transmissive plate 56 (holding surface sections 553a, 553b, and 553d). The second interposing member 572 is disposed on (attached to) the outer circumferential end surface 561c of the light transmissive plate 56, which faces the one side thereof, as described above.

### [Disposing Light Transmissive Plate 56 in Holding Section 552]

The light transmissive plate 56 is first inserted into the insertion section (area surrounded by upper holding section 555, holding surface section 553c, and wall section 554c) obliquely from above. In detail, the outer circumferential end surface 561c of the light transmissive plate 56, to which the second interposing member 572 is attached, is inserted into the insertion section. The second interposing member 572 is then caused to come into contact with the wall section 554c, which faces the insertion direction, and the light transmissive plate 56 is further inserted so that the second interposing member 572 is so pressed toward the wall section 554c as to compress. The inserted light transmissive plate 56 is then disposed on (tilted to) the holding surface sections 553a, 553b, and 553d, which are located inside the wall sections 554a, 554b, and 554d on the three sides. Upward movement of the side section 562c of the inserted light transmissive plate 56 is thus restricted.

After the light transmissive plate 56 is disposed on the holding surface section 553a, 553b, and 553d on the three sides, the two fixing plates 58 are disposed in the fixing section 558. In detail, the end surfaces 581 of the fixing plates 58 are oriented toward the opening 551, and the dowels 5583 of the fixing sections 558 are inserted into the holes 583, whereby the fixing plates 58 are positioned and placed on the placement surfaces 5581. The screws SC2 are then inserted through the holes 582 of the fixing plates 58 and screwed into the threaded holes 5582 of the fixing sections 558. The light transmissive plate 56 is therefore pressed by the fixing plates 58 and moved toward the holding surface section 553. When the light transmissive plate 56 is moved toward the holding surface section 553, the first interposing member 571 attached to the holding surface sections 553a, 553b, and 553d is so pressed as to compress toward the holding surface section 553.

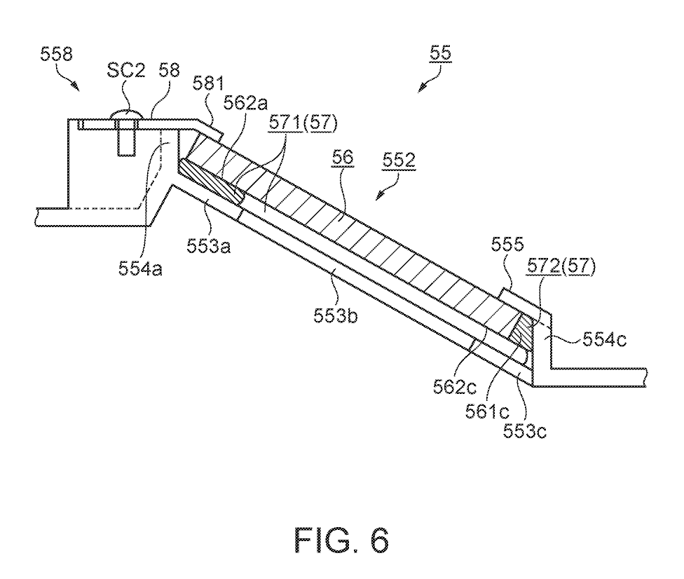

FIG. 6 is a schematic cross-sectional view of the state in which the light transmissive plate 56 is held in the holding section 552 and a cross-sectional view viewed from the left.

### [State of Gap in State Light Transmissive Plate 56 is Held in Holding Section 552]

In the state in which the light transmissive plate 56 is held in the holding section 552 and fixed to the holding section 552 by the fixing plates 58 and the upper holding section 555 (insertion section), the first interposing member 571 is so pressed by the light transmissive plate 56 as to compress toward the holding surface sections 553a, 553b, and 553d, as shown in FIG. 6. As a result, the gap between the light transmissive plate 56 (in detail, the side sections 562a, 562b, and 562d on the rear side) and the holding surface sections 553a, 553b, and 553d is closed by the first interposing member 571.

The second interposing member 572 is so pressed by the light transmissive plate 56 as to compress toward the wall section 554c. As a result, the gap between the light transmissive plate 56 (in detail, outer circumferential end surface 561c) and the wall section 554c is closed by the second interposing member 572.

At opposite end portions of the holding surface section 553c (areas where holding surface section 553c intersects holding surface sections 553b and 553d), the second interposing member 572 closes the gaps between the outer circumferential end surface 561c of the light transmissive plate 56 and the wall section 554c, and the first interposing member 571 closes the gaps between opposite end portions of the holding surface section 553c and the rear-side side section 562c of the light transmissive plate 56.

As described above, the light transmissive plate 56 is fixed with the gap between the light transmissive plate 56 and the holding section 552 (light transmissive plate holding section 55) closed by the first interposing member 571 and the second interposing member 572.

According to the embodiment described above, the following effects are provided:

In the optical projection apparatus 5 according to the present embodiment, the light transmissive plate 56 has a rectangular shape, and the second interposing member 572 is disposed on the outer circumferential end surface 561c of the light transmissive plate 56, which faces one side thereof. The outer circumferential end surface 561c of the light transmissive plate 56, which faces the one side thereof, is then inserted into the insertion section, which is part of the holding section 552 and corresponds to the outer circumferential end surface 561c (area surrounded by upper holding section 555, holding surface section 553c, and wall section 554c). In this case, the outer circumferential end surface 561c can be inserted without separation of the second interposing member 572, and the second interposing member 572 can be pressed against the holding section 552 (wall section 554c). The first interposing member 571 is disposed on the portions of the holding section 552 (holding surface sections 553a, 553b, and 553d) that correspond to the side section 562 (562a, 562b, and 562d), which faces the other three sides of the light transmissive plate 56, and the first interposing member 571 is pressed by the light transmissive plate 56. Therefore, in the case where the holding section 552 is not uniformly shaped but is oddly shaped, such as the light transmissive plate disposing structure in which the light transmissive plate 56 is inserted into the insertion section, the configuration in which the interposing member 57 is divided into the first interposing member 571 and the second interposing member 572 and the first interposing member 571 and the second interposing member 572 are pressed allows closure of the gap between the light transmissive plate 56 and the holding section 552. As a result, entry of dust flowing into the optical projection enclosure 51 can be suppressed.

In the optical projection apparatus 5 according to the present embodiment, the outer circumferential end surface 561c of the light transmissive plate 56, which faces one side thereof, is held by the insertion section, and the side section 562a of the side section 562 (562a, 562b, and 562d), which face the three sides of the light transmissive plate 56, is pressed by the pressing members (fixing plates 58). As a result, the light transmissive plate 56 is stably held in the light transmissive plate holding section 55 with the interposing member 57 pressed.

In the optical projection apparatus 5 according to the present embodiment, since the first interposing member 571 and the second interposing member 572 are each formed of a cushioning member, the first interposing member 571 and the second interposing member 572 can be readily formed.

The projector 1 according to the present embodiment, which includes the optical projection apparatus 5, which can suppress entry of dust flowing into the optical projection enclosure 51 through the gap between the light transmissive plate 56 and the optical projection enclosure 51 (holding section 552 of light transmissive plate holding section 55), allows improvement in the quality of a projected image.

The invention is not limited to the embodiment described above, and a variety of changes, improvements, and other modifications can be made to the extent that they do not depart from the substance of the invention. Variations will be described below.

In the optical projection apparatus 5 according to the embodiment described above, the holding section 552 is provided with the insertion section, and the outer circumferential end surface 561c to which the second interposing member 572 is attached is inserted into the insertion section to close the gap. However, even if the holding section 552 is provided with no insertion section, the interposing member 57 (second interposing member 572, for example) may be disposed on any part of the outer circumferential end surface 561 (outer circumferential end surface 561c, for example) of the light transmissive plate 56. In this case, for example, the outer circumferential end surface 561c can press the wall section 554c to compress the interposing member 572. As a result, even a case where a portion close to the wall section 554c, for example, the holding surface section 553c is not configured to be uniform with the other holding surface section 553a, 553b, or 553d, and the holding surface section 553c cannot therefore be used can be handled. In this case, the light transmissive plate 56 may be fixed by using the fixing sections 558, the fixing plates 58, and other components in the present embodiment.

In the optical projection apparatus 5 according to the embodiment described above, the side section 562a of the side section 562 (562a, 562b, and 562d), which faces the three sides of the light transmissive plate 56, is pressed by the pressing members (fixing plates 58), but not necessarily. Any of the side sections (side section 562b or 562d, for example) on which the first interposing member 571 is disposed may be pressed by the pressing members.

In the optical projection apparatus 5 according to the embodiment described above, the insertion section is formed at the lower wall section 554c in the holding section 552 (wall section 554) but may instead be formed at the upper wall section 554a. In this case, the fixing sections 558 may be formed at the lower wall section 554c. Further, in this case, a portion of the outer circumferential end surface 561 of the light transmissive plate 56, the portion on which the second interposing member 572 is disposed, may be inserted into the insertion section.

In the optical projection apparatus 5 according to the embodiment described above, the first interposing member 571 is disposed on the holding surface sections 553a, 553b, and 553d of the holding section 552 (holding surface section 553), but not necessarily. The first interposing member 571 may be disposed on the side sections 562a, 562b, and 562d of the light transmissive plate 56 that correspond to the holding surface sections 553a, 553b, and 553d. In this case, the second interposing member 572 is disposed on the outer circumferential end surface 561c of the light transmissive plate 56, and the first interposing member 571 is disposed on the side sections 562a, 562b, and 562d of the light transmissive plate 56.

In the optical projection apparatus 5 according to the embodiment described above, the first interposing member 571 has, in correspondence with the shape of the holding surface section 553 facing three sides thereof, a frame-like, plate-like shape with the lower one side cut off and is disposed on the holding surface sections 553a, 553b, and 553d of the holding section 552 (holding surface section 553). The second interposing member 572 has a rectangular plate-like shape in correspondence with the shape of the outer circumferential end surface 561c and is disposed on the outer circumferential end surface 561c of the light transmissive plate 56. The configuration described above is not, however, necessarily employed. The first interposing member 571 may have a rectangular plate-like shape in correspondence with the shape of the holding surface section 553 facing the one side thereof and may be disposed, for example, on the holding surface section 553a. The second interposing member 572 may, for example, have a rectangular plate-like shape corresponding to the shape (including length) of the outer circumferential end surfaces 561b, 561c, and 561d, and the thus formed second interposing member 572 may be attached to and along the outer circumferential end surfaces 561b, 561c, and 561d. The same effects described above can be provided when the light transmissive plate 56 is disposed in the holding section 552 in the configuration described above.

In the optical projection apparatus 5 according to the embodiment described above, the first interposing member 571 and the second interposing member 572 are formed of cushioning members having the same configuration (formed of polyethylene resin foam in the present embodiment), but not necessarily. The first interposing member 571 and the second interposing member 572 may be formed of different cushioning members. For example, the interposing members may be formed of cushioning members of the same type or cushioning members having different degrees of elasticity (hardness). The cushioning members themselves may have different configurations.

The light transmissive plate holding section 55 of the upper enclosure 53 in the embodiment described above is so formed that the opening 551 (see FIG. 5) has a rectangular shape, but the opening 551 may not necessarily have a rectangular shape and may have any shape that allows passage of the projection light reflected off the reflection mirror 71.

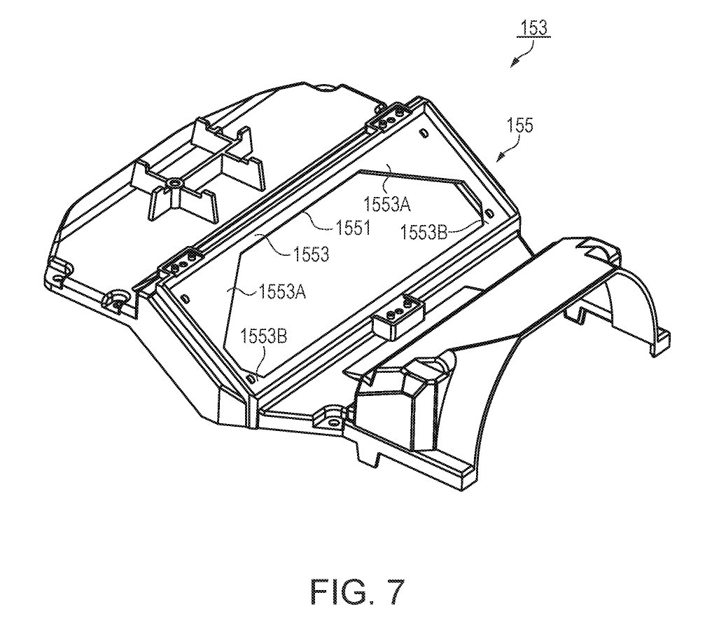

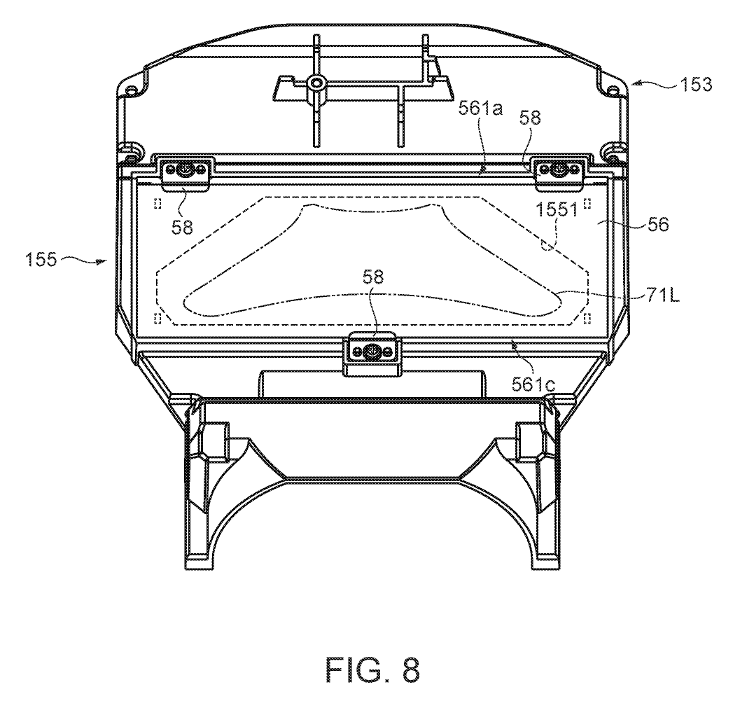

FIG. 7 is a perspective view showing an upper enclosure 153 according a variation. FIG. 8 is a plan view of the upper enclosure 153 in which the light transmissive plate 56 is disposed and which is viewed from the side where the light transmissive plate 56 is present. In FIG. 8, the two-dot chain line represents an area 71L where the projection light reflected off the reflection mirror 71 is incident on the light transmissive plate 56.

The area 71L is so shaped that the rear side (side facing outer circumferential end surface 561c of light transmissive plate 56) is wider than the front side (side facing outer circumferential end surfaces 561a of light transmissive plate 56), as shown in FIG. 8. An opening 1551 of a light transmissive plate holding section 155 in the upper enclosure 153 has a polygonal shape having an inner circumferential edge separate from the area 71L and similar to the shape of the area 71L. Specifically, a holding surface section 1553, which has the opening 1551, has a shape extending to the four corners of the rectangular opening 551. Extension sections 1553A, which extend to the front corners, are wider than extension sections 1553B, which extend to the rear corners, and the opening 1551 has an octagonal shape.

As described above, since the holding surface section 1553 is so formed as to be wide, entry of dust flowing into the optical projection enclosure 51 can be further suppressed, and leaking light that does not contribute to a projected image and other unwanted light can be blocked, whereby the quality of a projected image can be improved.

In the embodiment described above, the light transmissive plate 56 is held by using the two fixing plates 58 and the upper holding section 555 (see FIG. 3). It is conceivable to employ a configuration in which the upper holding section 555 may be replaced with a fixing plate 58, that is, a configuration in which the light transmissive plate 56 is held by using three fixing plates 58, as shown in FIG. 8.

The projector 1 according to the embodiment described above is so installed on the wall surface W via the support apparatus SD that the bottom surface 1A faces upward and projects an image on the screen SC, which is installed below the projector 1, as shown in FIG. 1. The installation of the projector 1 is, however, not limited to a specific manner, and the projector 1 may be installed on a ceiling surface, a floor surface, a desktop, or any other surface and may project an image on the screen SC installed on the wall surface W. Still instead, the projector 1 may be installed on a desktop and may project an image on the same desktop.

In the projector 1 according to the embodiment described above, the electro-optical apparatus 35 employs what is called a three-panel method using three light modulators corresponding to R light, G light, and B light, but not necessarily, and may instead employ a single-panel light modulator. Further, an additional light modulator for improving contrast may be employed.

In the projector 1 according to the embodiment described above, the electro-optical apparatus 35 employs transmissive light modulators (transmissive liquid crystal panels 351), but not necessarily, and may instead employ reflective light modulators.

In the projector 1 according to the embodiment described above, the electro-optical apparatus 35 employs the liquid crystal panels 351 as the light modulators, but not necessarily, and may, in general, employ any component that modulates an incident light flux on the basis of an image signal, for example, a micromirror-type light modulator or a light modulator based on any other method. A DMD (digital micromirror device) can, for example, be employed as the micromirror-type light modulator.

In the projector 1 according to the embodiment described above, the optical unit 3 employs a lens integrator system formed of the lens arrays 321 and 322 as the illumination optical apparatus 32, which homogenizes the illuminance of the light flux outputted from the light source apparatus 31, but not necessarily, and can employ a rod integrator system formed of a light guide rod.

In the optical unit 3 in the projector 1 according to the embodiment described above, the light source lamp 311 in the light source apparatus 31 employs an ultrahigh-pressure mercury lamp or any other discharge lamp but may instead employ a laser diode, an LED (light emitting diode), an organic EL (electro luminescence) device, a silicon-based light emitting device, or any of a variety of other solid-state light emitting devices.

### REFERENCE SIGNS LIST

The entire disclosure of Japanese Patent Application No. 2015-062190, filed Mar. 25, 2015 and Japanese Patent Application No. 2015-210544, filed Oct. 27, 2015 are expressly incorporated by reference herein.

1-5. (canceled)

6. A optical projection apparatus including a refractive system having a plurality of lenses and a reflective system having a reflection mirror, wherein the optical projection apparatus comprises:
a optical projection enclosure that accommodates the refractive system and the reflective system; and
a light transmissive plate that is disposed in the optical projection enclosure and transmits projection light having exited out of the reflective system,
the optical projection enclosure includes a light transmissive plate holding section that holds the light transmissive plate,
the light transmissive plate holding section includes an opening through which the projection light passes and a holding section which is formed along the opening and in which the light transmissive plate is disposed,
an interposing member having elasticity is provided between the light transmissive plate and the holding section,
the interposing member is formed of a first interposing member and a second interposing member that correspond to divided portions of the holding section and cover the entire holding section,
the first interposing member is disposed in the holding section or on a side section of the light transmissive plate, and the second interposing member is disposed on an outer circumferential end surface of the light transmissive plate, and
the light transmissive plate presses the first interposing member and the second interposing member against the holding section and is held by the light transmissive plate holding section.

7. The optical projection apparatus according to claim 6, wherein
the light transmissive plate has a rectangular shape,
the holding section corresponding to an outer circumferential end surface of the light transmissive plate facing one side thereof has an insertion section into which the outer circumferential end surfaces is inserted,
the second interposing member is disposed on the outer circumferential end surfaces facing the one side, and
the first interposing member is disposed on side sections of the light transmissive plate facing other three sides thereof or in the holding section corresponding to the side sections.

8. The optical projection apparatus according to claim 6, wherein
the light transmissive plate has a rectangular shape,
a pressing member that presses any of the side sections of the light transmissive plate on which the first interposing member is disposed is provided, and
the pressing member holds the light transmissive plate in the light transmissive plate holding section.

9. The optical projection apparatus according to claim 6, wherein
the first interposing member and the second interposing member are each formed of a cushioning member.

10. The optical projection apparatus according to claim 7, wherein
the first interposing member and the second interposing member are each formed of a cushioning member.

11. The optical projection apparatus according to claim 8, wherein
the first interposing member and the second interposing member are each formed of a cushioning member.

12. A projector wherein the projector comprises:
a light source apparatus that outputs light;
a light modulator that modulates the light in accordance with image information;
the optical projection apparatus according to claim 6, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.

13. A projector wherein the projector comprises:
a light source apparatus that outputs light;
a light modulator that modulates the light in accordance with image information;
the optical projection apparatus according to claim 7, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.

14. A projector wherein the projector comprises:
a light source apparatus that outputs light;
a light modulator that modulates the light in accordance with image information;
the optical projection apparatus according to claim 8, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.

15. A projector wherein the projector comprises:
a light source apparatus that outputs light;
a light modulator that modulates the light in accordance with image information;
the optical projection apparatus according to claim 9, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.

16. A projector wherein the projector comprises:
a light source apparatus that outputs light;
a light modulator that modulates the light in accordance with image information;
the optical projection apparatus according to claim 10, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.

17. A projector wherein the projector comprises:
a light source apparatus that outputs light;
a light modulator that modulates the light in accordance with image information;
the optical projection apparatus according to claim 11, which projects the light modulated by the light modulator; and
an exterior enclosure that accommodates the light source apparatus, the light modulator, and the optical projection apparatus and forms an exterior of the projector, and
the exterior enclosure has, in correspondence with the opening of the optical projection enclosure, an opening through which the projection light having passed through the opening of the optical projection enclosure passes.
